(19) United States
(12) Patent Application Publication
(10) Pub. No.: US 2023/0213767 A1
(43) Pub. Date: Jul. 6, 2023

(54) Eye Glow Suppression in Waveguide Based Displays

(71) Applicant: DigiLens Inc., Sunnyvale, CA (US)

(72) Inventors: Alastair John Grant, San Jose, CA (US); Milan Momcilo Popovich, Leicester (GB); Nicholas Sherwood, Sunnyvale, CA (US); Roger Allen Conley Smith, Sunnyvale, CA (US); Michiel Koen Callens, Sunnyvale, CA (US); Nima Shams, Sunnyvale, CA (US)

(73) Assignee: DigiLens Inc., Sunnyvale, CA (US)

(21) Appl. No.: 17/999,662

(22) PCT Filed: May 26, 2021
(86) PCT No.: PCT/US21/34315

§ 371 Date: Nov. 22, 2022

Related U.S. Application Data
(60) Provisional application No. 63/128,645, filed on Dec. 21, 2020.
(60) Provisional application No. 63/039,938, filed on Jun. 16, 2020.
(60) Provisional application No. 63/030,265, filed on May 26, 2020.

(51) Int. Cl. G02B 27/01; F21V 8/00; G02B 27/00

(52) U.S. Cl. CPC G02B 27/0172; G02B 6/005; G02B 27/0043

(57) ABSTRACT

Methods and apparatus for eye-glow suppression in waveguide systems is disclosed herein. Some embodiments of the methods and the apparatus include a waveguide based display including a waveguide including an in-coupling optical element and an out-coupling optical element, where the in-coupling optical element is configured to in-couple image containing light and the out-coupling optical element is configured to out-couple the image counting light towards a user, where the waveguide comprises an outer surface and an inner surface opposite to the outer surface, and wherein the inner surface is closer to the user than the outer surface; and a partially light blocking layer above the outer surface of the waveguide opposite to the user, where the partially light blocking layer is configured to keep eye glow light from entering the environment outside the outer surface of the waveguide.

### CROSS-REFERENCED APPLICATIONS

This application claims priority to U.S. Provisional Application 63/030,265 filed on May 26, 2020, U.S. Provisional Application 63/039,938 filed on Jun. 16, 2020, U.S. Provisional Application 63/128,645 filed Dec. 21, 2020, and U.S. Provisional Application 63/129,270 filed Dec. 22, 2020, the disclosures of which are herein incorporated by reference in their entirety.

### FIELD OF THE INVENTION

The present invention generally relates to suppressing eye glow in waveguide systems.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (AR) and virtual reality (VR), compact head-up displays (HUDs) and helmet-mounted displays or head-mounted displays (HMDs) for road transport, aviation, and military applications, and sensors for biometric and laser radar (LIDAR) applications.

### SUMMARY OF THE DISCLOSURE

Various embodiments are directed to waveguide based display devices including:
a waveguide comprising an in-coupling optical element and an out-coupling optical element, where the in-coupling optical element is configured to in-couple image modulated light and the out-coupling optical element is configured to out-couple the image modulated light towards a user, wherein the waveguide includes an outer surface and an inner surface opposite to the outer surface, and where the inner surface is closer to the user than the outer surface; and
a partially light blocking layer above the outer surface of the waveguide opposite to the user,
where the partially light blocking layer is configured to keep eye glow light exiting the outer surface of the waveguide from entering the environment outside the outer surface of the waveguide.

In various embodiments, the eye glow light includes light directed out of the outer surface away from the user.

In still various embodiments, the eye glow light is light reflected by the out-coupling optical element, the in-coupling optical element, and/or the inner surface.

In still various embodiments, the waveguide causes the in-coupled light to be directed in total internal reflection (TIR) between the inner surface and the outer surface.

In still various embodiments, the partially light blocking layer absorbs light in a portion of the visible light spectrum.

In still various embodiments, the partially light blocking layer includes a narrowband dye absorber layer.

In still various embodiments, the narrowband dye absorber layer includes a light absorbing dye suspended in a transparent matrix.

In still various embodiments, the partially light blocking layer includes a metamaterial absorbing layer.

In still various embodiments, the metamaterial absorbing layer includes an absorber formed in a metamaterial.

In still various embodiments, the partially light blocking layer deflects light in a portion of the visible light spectrum toward the user.

In still various embodiments, the partially light blocking layer includes a dielectric or dichroic reflector.

In still various embodiments, the partially light blocking layer transforms the light in a portion of the visible light spectrum to non-visible radiation.

In still various embodiments, the partially light blocking layer includes quantum dots or phosphors.

In still various embodiments, the partially light blocking layer diffracts light in a portion of the visible light spectrum into a path that does not enter the environment.

In still various embodiments, the partially light blocking layer includes a reflective or transmissive diffractive structure.

In still various embodiments, the partially light blocking layer includes a reflective grating layer.

In still various embodiments, the reflective grating layer is configured to direct light towards a light absorbing element.

In still various embodiments, the reflective grating layer is positioned between two waveguide substrates.

In still various embodiments, the reflective grating layer includes a holographically recorded grating.

In still various embodiments, the partially light blocking layer includes a plurality of overlapping diffractive structures, each structure configured to diffract a unique angular bandwidth of eye-glow light and diffract it onto a light absorbing element.

In still various embodiments, the partially light blocking layer includes a plurality of multiplexed diffractive structures, each multiplexed diffractive structure configured to diffract a unique angular bandwidth of eye glow light onto a light absorber.

In still various embodiments, the partially light blocking layer is coated directly on the waveguide.

In still various embodiments, the partially light blocking layer is coated on a substrate disposed on the waveguide.

In still various embodiments, spacers are positioned between the substrate and the waveguide to form a gap between the substrate and the waveguide.

In still various embodiments, the gap is an air gap.

In still various embodiments, the substrate includes a protective layer.

In still various embodiments, the display device further includes another waveguide positioned below the waveguide.

In still various embodiments, the display device further includes spacers disposed between the waveguide and the other waveguide to form a gap between the waveguide and the other waveguide.

In still various embodiments, the gap includes an air gap.

In still various embodiments, the display device further includes another partially light blocking layer, where the other waveguide is configured to display a different wavelength of light than the waveguide, where the partially light blocking layer is configured to block a wavelength of light corresponding to the wavelength of light the waveguide is configured to display, and where the other partially light blocking layer is configured to block the wavelength of light corresponding to the wavelength of light the other waveguide is configured to display.

In still various embodiments, the other waveguide is configured to display a different wavelength of light than the waveguide, where the partially light blocking layer is configured to block the wavelength of light corresponding to the wavelength of light of the waveguide and the other waveguide.

In still various embodiments, the waveguide is a first waveguide and the display device further includes a second waveguide and a third waveguide.

In still various embodiments, the first waveguide, the second waveguide, and the third waveguide are each configured to display different wavelengths of light.

In still various embodiments, the partially light blocking layer is a first partially light blocking layer and the display device further includes a second partially light blocking layer and a third partially light blocking layer, where the first partially light blocking layer is configured to block the wavelength of light corresponding to the wavelength of light the first waveguide is configured to display, where the second partially light blocking layer is configured to block the wavelength of light corresponding to the wavelength of light the second waveguide is configured to display, and where the third partially light blocking layer is configured to block the wavelength of light corresponding to the wavelength of light the third waveguide is configured to display.

In still various embodiments, the second waveguide is disposed between the first waveguide and the second waveguide.

In still various embodiments, the second partially light blocking layer is formed on a top surface of the second waveguide.

In still various embodiments, the second partially light blocking layer is formed on a substrate disposed above the first waveguide.

In still various embodiments, the display device further includes spacers disposed between the substrate and the first waveguide to form an air gap between the substrate and the first waveguide.

In still various embodiments, the substrate includes a protective layer.

In still various embodiments, the partially light blocking layer overlaps the out-coupling optical element and not the in-coupling optical element.

Further, various embodiments are directed to an augmented or mixed reality head-worn display device including: the display device described throughout this disclosure; and a projector configured to project the image containing light towards the in-coupling optical element.

In still various embodiments, the partially light blocking layer comprises a liquid crystal polymer or a cholesteric liquid crystal.

In still various embodiments, the partially light blocking layer comprises a linear polarizer aligned with a principal k-vector parallel with the out-coupling optical element.

In still various embodiments, the partially light blocking layer includes a phase scrambler that causes light to be directed back into the waveguide by the phase scrambler to be out of phase with image light out-coupled towards the user by the out coupling optical element.

In still various embodiments, the partially light blocking layer includes a microlouver film.

Further, various embodiments are directed to a method of suppressing eye glow light, the method comprising:
providing:
   a source of image modulated light,
   a waveguide with an inner reflecting surface in proximity to a user's eye and an outer reflecting surface positioned above the inner reflecting surface, the waveguide supporting an in-coupling optical element and an out-coupling optical element, and
   a partially light blocking layer above the outer reflecting surface;
coupling image modulated light from the source of image modulated light into the waveguide;
extracting image modulated light for viewing out of the waveguide towards a user using the out-coupling optical element; and
blocking off-Bragg image modulated light from leaving the waveguide as eye glow light via the outer surface using the partially light blocking layer.

In various embodiments, blocking the off-Bragg image modulated light includes absorbing the off-Bragg image modulated light.

In still various embodiments, blocking the off-Bragg image modulated light includes deflecting the off-Bragg image modulated light toward the user.

In still various embodiments, blocking the off-Bragg image modulated light includes transforming the off-Bragg image modulated light into non-visible radiation.

In still various embodiments, blocking the off-Bragg image modulated light includes diffracting the off-Bragg image modulated light into a path that does not enter the environment.

In still various embodiments, the method further includes absorbing the diffracted off-Bragg image modulated light.

In still various embodiments, the method further includes attenuating the diffracted off-Bragg image modulated light.

### BRIEF DESCRIPTION OF THE DRAWINGS

The description will be more fully understood with reference to the following figures, which are presented as exemplary embodiments of the invention and should not be construed as a complete recitation of the scope of the invention.

FIG. 1A conceptually illustrates the eye glow phenomenon as a product of off-Bragg interaction in accordance with an embodiment of the invention.

FIG. 1B conceptually illustrates the eye glow phenomenon as a product of Fresnel reflection in accordance with an embodiment of the invention.

FIG. 2 illustrates a waveguide display incorporating diffractive elements as an eye glow suppression layer in accordance with an embodiment of the invention.

FIG. 3A illustrates a waveguide display incorporating diffractive elements in an eye glow suppression layer in accordance with an embodiment of the invention.

FIG. 3B illustrates an example of an eye glow suppression layer including transmission diffractive elements in accordance with an embodiment of the invention.

FIG. 3C illustrates an example of an eye glow suppression layer including reflective diffractive elements in accordance with an embodiment of the invention.

FIG. 4 illustrates a waveguide display implementing a surface relief grating for eye glow suppression in accordance with an embodiment of the invention.

FIG. 5 illustrates a reflection grating disposed on a separate substrate for suppressing eye glow in accordance with an embodiment of the invention.

FIG. 6 illustrates a waveguide display including a dichroic reflector coating in accordance with an embodiment of the invention.

FIG. 7 illustrates a configuration of a waveguide-based display including three different waveguides in accordance with an embodiment of the invention.

FIG. 8 illustrates a configuration of a waveguide-based display including three different waveguides in accordance with an embodiment of the invention.

FIG. 9 illustrates a configuration of a waveguide-based display including three different waveguides in accordance with an embodiment of the invention.

FIG. 10A illustrates a cross sectional view of a waveguide-based display including a dichroic filter in accordance with an embodiment of the invention.

FIG. 10B is a schematic plan view of the waveguide-based display illustrated in FIG. 10A.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

In waveguide-based displays light may be diffracted toward the user and also away from the user. Eye glow may include unwanted light emerging from the front face of a display waveguide (e.g. the waveguide face furthest from the eye) and originating at a reflective surface of the eye, a waveguide reflective surface and a surface of grating (due to leakage, stray light diffractions, scatter, and other effects). The light that is diffracted away is commonly called “eye-glow” and poses a liability for security, privacy, and social acceptability. “Eye glow” may refer to the phenomenon in which a user's eyes appear to glow or shine through an eye display caused by leakage of light from the display, which creates an aesthetic that can be unsettling to some people. In addition to concerns regarding social acceptability in a fashion sense, eye glow can present a different issue where, when there is sufficient clarity to the eye glow, a viewer looking at the user may be able to see the projected image intended for only the user. As such, eye glow can pose a serious security concern for many users. There are many sources of eye glow in near-eye displays, including but not limited to Fresnel reflections and off-Bragg diffractions. This may be an issue for all diffractive waveguide solutions (surface relief gratings, volume Bragg gratings, etc.) and optical combiner methods that may utilize see-through. In addition to blocking unwanted eye-glow light, the waveguides may maintain high transmission to allow the observer to still see the real world. Furthermore, the need for eye contact drives a highly transparent waveguide while blocking eye-glow light. Suppressing eye-glow light may be a selective light blocking technique for all waveguide and optical combiner augmented reality or mixed reality wearable devices. Eye-glow suppression may also be applied to waveguide based heads-up displays such as automotive heads-up displays or aerospace applied heads-up displays

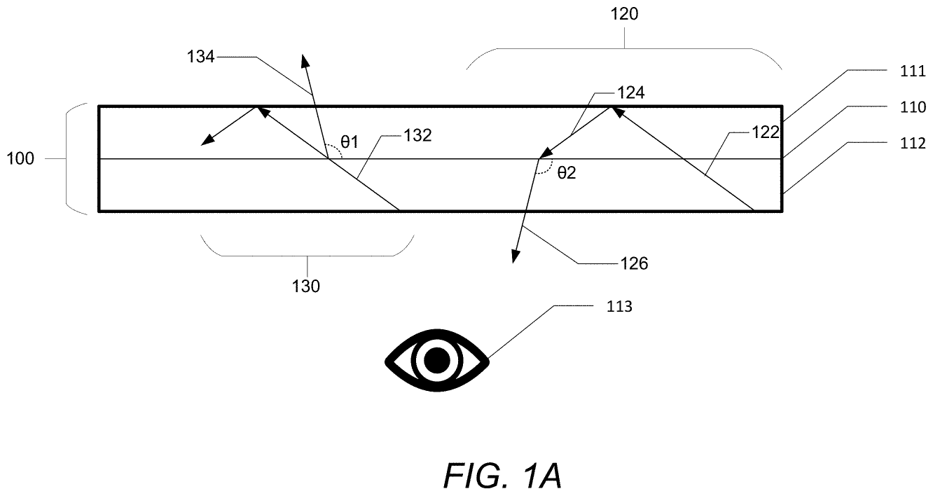

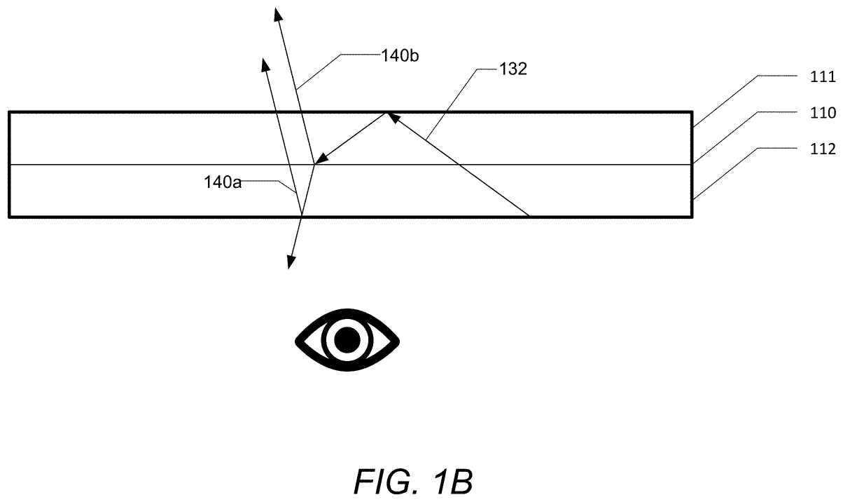

Waveguide architectures described herein can mitigate or suppress eye glow using a variety of different methods that can be used separately or in conjunction as appropriate depending on the application. Turning now to the drawings, in order to better illustrate the problem of eye glow, a diagram illustrating a source of eye glow in a waveguide display accordance with an embodiment of the invention is conceptually illustrated in FIG. 1A. The waveguide 100 includes a grating layer 110 that includes one or more holographic grating sandwiched between two substrates 111,112.

Area 120 of the waveguide 100 illustrates the intended operation of the waveguide display. In many embodiments, the holographic grating is designed to diffract beams under Bragg diffraction towards the eye side of the waveguide display. As shown, a beam 122 traveling within the waveguide 100 in a TIR path is diffracted at a predetermined angle θ2 towards the eye side of the waveguide 100 upon interaction with a grating within the grating layer 110, passing through to the eyes 113 of a viewer. In some embodiments, light may be diffracted toward the eye side and also away from the eye side. The light that is diffracted away is commonly called “eye-glow” and poses a liability for security, privacy, and social acceptability. Area 130 of the waveguide 100 illustrates an off-Bragg interaction, which is a substantial source of eye glow in many waveguide displays. The incident beam 132 is weakly diffracted due to an off-Bragg interaction with a grating in the grating layer 110, causing a portion of the beam 132 to be diffracted at the predetermined angle θ1 as eye glow beam 134, which passes through to the side opposite the eye side (or the environmental side—i.e., the side opposite the output side) of the waveguide 100. This eye glow beam, when seen by an outside observer, can appear as eye glow. While the “eye side” is used herein to discuss the intended direction of diffraction, it can be readily appreciated that off-Bragg interaction can pose an issue for optic systems not designed to be worn over an eye, and therefore the architectures described herein can be easily applied to any optic system suffering from similar issues. For example, in a sensor, the off-Bragg light paths may result in stray light paths that can reduce the signal to noise ratio of the sensor. Eye glow can be an issue with infrared waveguides as well. For example, off-Bragg paths in eye trackers could result in detectable infrared emissions.

While the eye glow phenomenon and the intended operation are shown as occurring in separate locations of the waveguide 100, it is to be understood that the eye glow phenomenon and the intended operation can in fact occur concurrently throughout the waveguide display depending on the architecture of the device. Furthermore, while a significant contributor to eye glow is illustrated in FIG. 1A, it is contemplated that other factors can contribute to eye glow. For example, Fresnel reflection on the surface interface on the eye side of the waveguide display can also result in eye glow. In some cases, scattering may also take place on the surface of the user's eye or solar illumination entering the waveguide and getting diffracted out of the waveguide.

Examples of reflections that cause eye glow in accordance with an embodiment of the invention is conceptually illustrated in FIG. 1B. As shown, a beam diffracted towards the user's eye can have a portion reflected back at the surface interface which represents a Fresnel reflection. The reflected beam 140a may travel through the waveguide and exit on the environmental side of the waveguide as an eye glow beam. A reflected beam 140b may also be produced by the grating layer 110. It is to be noted that FIGS. 1A and 1B illustrate general ray paths and interactions and may not show the nature of waveguiding optics in its entirety. For example, rays exiting and entering the waveguide at non-normal angles can result in a refractive change in angle at the waveguide's surfaces. With this understanding of the different sources of eye glow, different proposed eye glow suppression structures are described in further detail below.

### Eye Glow Suppression Structures

Architectures for suppressing eye glow in accordance with various embodiments of the invention attempt to mitigate the cause of eye glow by reflecting and/or redirecting eye glow beams. Eye glow suppression structures can be introduced multiple times in the same display system, the specific configuration of which can be based on the particular system. For example, in systems that use multiple different waveguides (e.g. for different wavelength and/or angular bands), multiple eye glow suppression structures can be included in the overall system. In numerous embodiments, a single eye glow suppression structure can be included that mitigates eye glow beams from multiple waveguides. In addition to block the unwanted eye-glow light, the waveguides have high transmission to allow a user to see the real world. Thus, a highly transparent waveguide is advantageous while simultaneously blocking eye-glow light. Suppressing eye-glow light may be a selective light blocking technique for all waveguide and optical combiner AR/XR wearables.

In many embodiments, a diffractive element such as at least one reflection grating can be implemented to suppress a substantial portion of eye glow within a waveguide display. In multi-layered waveguide display systems, a grating layer having at least one of such reflection gratings can be implemented for each waveguide layer. The reflection grating can be implemented in many different ways. In some embodiments, the reflection grating is implemented as a holographic grating in a grating layer within a secondary waveguide. This secondary reflection waveguide can be disposed adjacent the base waveguide. In such configurations, the substrates of the two waveguides can be index-matched to provide a single TIR structure within which light can propagate. In several embodiments, the reflection waveguide and the base waveguide can be configured with an air gap in between. In a number of embodiments, the reflection grating is implemented in a grating layer disposed adjacent the substrate facing the environmental side and opposite the grating layer of the base waveguide. In such cases, the waveguide display can include three substrate layers that alternate and interleave with the two grating layers, forming a single TIR structure. The reflection grating can also be implemented as a surface relief grating. For example, a surface reflection grating can be implemented on the surface of the environmental side of the waveguide.

As described above, each waveguide layer in a multi-layered waveguide display can include a reflection grating, or reflection grating layer, for suppressing eye glow. Depending on the application, the reflection grating can be configured to reflect a predetermined wavelength and/or angular band. For example, in a three-layered RGB waveguide display system, each of the R, G, and B layer can be implemented with a respective reflection grating, or reflection grating layer, configured to reflect a spectral wavelength band corresponding to the layer (i.e., a reflection grating designed to reflect red light can be implemented for the R layer of the waveguide display). In several embodiments, the reflection gratings can be multiplexed. In a number of embodiments, the reflection grating(s) can be recorded or formed with grating vectors that conform to the rake angle of the waveguide display.

In addition to or in place of reflection gratings, filters can be utilized to suppress eyeglow. For example, a dichroic reflector or a dielectric mirror (e.g. dielectric reflector) can be applied and implemented on the surface of the environmental side of the waveguide. Similar to the configurations described above, a multi-layered waveguide display system can include a dichroic reflector for each waveguide layer, where each dichroic reflector is configured to reflect a specific wavelength and/or angular band corresponding to the individual waveguide layer. In many embodiments, the waveguide display includes an additional protective layer. In such cases, one of the dichroic reflectors desired for implementation can be incorporated onto the protective layer.

Another method for suppressing eye glow includes the use of quantum dots, which structures that can absorb light of a first wavelength and emit light of a second wavelength. In many embodiments, quantum dots can be incorporated within the substrate adjacent the environmental side of the waveguide. The quantum dots can be configured to absorb specific wavelengths of light corresponding to the particular waveguide layer within which it is incorporated. For example, quantum dots configured to absorb certain wavelengths of red corresponding to the red light source can be incorporated in a substrate of the red waveguide layer. The quantum dots can be further configured to emit light shifted to a predetermined wavelength band (e.g. infrared), allowing for the suppression of eye glow.

As can readily be appreciated, several methods and structures for suppressing eye glow can be implemented as appropriate in accordance with various embodiments of the invention. The specific configuration to be implemented can depend on the application. In many cases, the choice of method and structure utilized can include the balance of several factors, including but not limited to see-through transmission, suppression performance, costs, etc. Further, as noted above, rays that interact with the eye side interface can be reflected due to Fresnel reflection, resulting in eye glow. In many embodiments, eye glow rays due to Fresnel reflection can be mostly (or entirely) mitigated using an antireflective coating on the eye side surface of the waveguide. Optical structures, eye glow suppression structures, and related methods of implementation and application are discussed in turn below.

### Optical Waveguide and Grating Structures

Optical structures recorded in waveguides can include many different types of optical elements, such as but not limited to diffraction gratings. Gratings can be implemented to perform various optical functions, including but not limited to coupling light, directing light, and preventing the transmission of light. In many embodiments, the gratings are surface relief gratings that reside on the outer surface of the waveguide. In other embodiments, the grating implemented is a Bragg grating (also referred to as a volume grating), which are structures having a periodic refractive index modulation. Bragg gratings can be fabricated using a variety of different methods. One process includes interferential exposure of holographic photopolymer materials to form periodic structures. Bragg gratings can have high efficiency with little light being diffracted into higher orders. The relative amount of light in the diffracted and zero order can be varied by controlling the refractive index modulation of the grating, a property that can be used to make lossy waveguide gratings for extracting light over a large pupil.

One class of Bragg gratings used in holographic waveguide devices is the Switchable Bragg Grating (SBG). SBGs can be fabricated by first placing a thin film of a mixture of photopolymerizable monomers and liquid crystal material between substrates. The substrates can be made of various types of materials, such glass and plastics. In many cases, the substrates are in a parallel configuration. In other embodiments, the substrates form a wedge shape. One or both substrates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many embodiments, HPDLC material is used. During the recording process, the monomers polymerize, and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (ITO). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 μs with a longer relaxation time to switch ON. The diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The substrates used to form the HPDLC cell provide a total internal reflection (TIR) light guiding structure. Light can be coupled out of the SBG when the switchable grating diffracts the light at an angle beyond the TIR condition.

In some embodiments, LC can be extracted or evacuated from the SBG to provide an evacuated Bragg grating (EBG). EBGs can be characterized as a surface relief grating (SRG) that has properties very similar to a Bragg grating due to the depth of the SRG structure (which is much greater than that practically achievable using surface etching and other conventional processes commonly used to fabricate SRGs). The LC can be extracted using a variety of different methods, including but not limited to flushing with isopropyl alcohol and solvents. In many embodiments, one of the transparent substrates of the SBG is removed, and the LC is extracted. In further embodiments, the removed substrate is replaced. The SRG can be at least partially backfilled with a material of higher or lower refractive index. Such gratings offer scope for tailoring the efficiency, angular/spectral response, polarization, and other properties to suit various waveguide applications. Examples of EBGs and methods for manufacturing EBGs are discussed in US Pat. Pub. No. 2021/0063634, entitled “Evacuating Bragg Gratings and Methods of Manufacturing” and filed Aug. 28, 2020 which is hereby incorporated by reference in its entirety.

Waveguides in accordance with various embodiments of the invention can include various grating configurations designed for specific purposes and functions. In many embodiments, the waveguide is designed to implement a grating configuration capable of preserving eyebox size while reducing lens size by effectively expanding the exit pupil of a collimating optical system. The exit pupil can be defined as a virtual aperture where only the light rays which pass though this virtual aperture can enter the eyes of a user. In some embodiments, the waveguide includes an input grating optically coupled to a light source, a fold grating for providing a first direction beam expansion, and an output grating for providing beam expansion in a second direction, which is typically orthogonal to the first direction, and beam extraction towards the eyebox. As can readily be appreciated, the grating configuration implemented waveguide architectures can depend on the specific requirements of a given application. In some embodiments, the grating configuration includes multiple fold gratings. In several embodiments, the grating configuration includes an input grating and a second grating for performing beam expansion and beam extraction simultaneously. The second grating can include gratings of different prescriptions, for propagating different portions of the field-of-view, arranged in separate overlapping grating layers or multiplexed in a single grating layer. Furthermore, various types of gratings and waveguide architectures can also be utilized.

In several embodiments, the gratings within each layer are designed to have different spectral and/or angular responses. For example, in many embodiments, different gratings across different grating layers are overlapped, or multiplexed, to provide an increase in spectral bandwidth. In some embodiments, a full color waveguide is implemented using three grating layers, each designed to operate in a different spectral band (red, green, and blue). In other embodiments, a full color waveguide is implemented using two grating layers, a red-green grating layer and a green-blue grating layer. As can readily be appreciated, such techniques can be implemented similarly for increasing angular bandwidth operation of the waveguide. In addition to the multiplexing of gratings across different grating layers, multiple gratings can be multiplexed within a single grating layer—i.e., multiple gratings can be superimposed within the same volume. In several embodiments, the waveguide includes at least one grating layer having two or more grating prescriptions multiplexed in the same volume. In further embodiments, the waveguide includes two grating layers, each layer having two grating prescriptions multiplexed in the same volume. Multiplexing two or more grating prescriptions within the same volume can be achieved using various fabrication techniques. In a number of embodiments, a multiplexed master grating is utilized with an exposure configuration to form a multiplexed grating. In many embodiments, a multiplexed grating is fabricated by sequentially exposing an optical recording material layer with two or more configurations of exposure light, where each configuration is designed to form a grating prescription. In some embodiments, a multiplexed grating is fabricated by exposing an optical recording material layer by alternating between or among two or more configurations of exposure light, where each configuration is designed to form a grating prescription. As can readily be appreciated, various techniques, including those well known in the art, can be used as appropriate to fabricate multiplexed gratings.

In many embodiments, the waveguide can incorporate at least one of: angle multiplexed gratings, color multiplexed gratings, fold gratings, dual interaction gratings, rolled K-vector gratings, crossed fold gratings, tessellated gratings, chirped gratings, gratings with spatially varying refractive index modulation, gratings having spatially varying grating thickness, gratings having spatially varying average refractive index, gratings with spatially varying refractive index modulation tensors, and gratings having spatially varying average refractive index tensors. In some embodiments, the waveguide can incorporate at least one of: a half wave plate, a quarter wave plate, an anti-reflection coating, a beam splitting layer, an alignment layer, a photochromic back layer for glare reduction, and louvre films for glare reduction. In several embodiments, the waveguide can support gratings providing separate optical paths for different polarizations. In various embodiments, the waveguide can support gratings providing separate optical paths for different spectral bandwidths. In a number of embodiments, the gratings can be HPDLC gratings, switching gratings recorded in HPDLC (such switchable Bragg Gratings), Bragg gratings recorded in holographic photopolymer, or surface relief gratings. In many embodiments, the waveguide operates in a monochrome band. In some embodiments, the waveguide operates in the green band. In several embodiments, waveguide layers operating in different spectral bands such as red, green, and blue (RGB) can be stacked to provide a three-layer waveguiding structure. In further embodiments, the layers are stacked with air gaps between the waveguide layers. In various embodiments, the waveguide layers operate in broader bands such as blue-green and green-red to provide two-waveguide layer solutions. In other embodiments, the gratings are color multiplexed to reduce the number of grating layers. Various types of gratings can be implemented. In some embodiments, at least one grating in each layer is a switchable grating.

Waveguides incorporating optical structures such as those discussed above can be implemented in a variety of different applications, including but not limited to waveguide displays. In various embodiments, the waveguide display is implemented with an eyebox of greater than 10 mm with an eye relief greater than 25 mm. In some embodiments, the waveguide display includes a waveguide with a thickness between 2.0-5.0 mm. In many embodiments, the waveguide display can provide an image field-of-view of at least 50° diagonal. In further embodiments, the waveguide display can provide an image field-of-view of at least 70° diagonal. The waveguide display can employ many different types of picture generation units (PGUs). In several embodiments, the PGU can be a reflective or transmissive spatial light modulator such as a liquid crystal on Silicon (LCoS) panel or a micro electromechanical system (MEMS) panel. In a number of embodiments, the PGU can be an emissive device such as an organic light emitting diode (OLED) panel. In some embodiments, an OLED display can have a luminance greater than 4000 nits and a resolution of 4 k×4 k pixels. In several embodiments, the waveguide can have an optical efficiency greater than 10% such that a greater than 400 nit image luminance can be provided using an OLED display of luminance 4000 nits. Waveguides implementing P-diffracting gratings (i.e., gratings with high efficiency for P-polarized light) typically have a waveguide efficiency of 5%-6.2%. Since P-diffracting or S-diffracting gratings can waste half of the light from an unpolarized source such as an OLED panel, many embodiments are directed towards waveguides capable of providing both 5-diffracting and P-diffracting gratings to allow for an increase in the efficiency of the waveguide by up to a factor of two. In some embodiments, the S-diffracting and P-diffracting gratings are implemented in separate overlapping grating layers. Alternatively, a single grating can, under certain conditions, provide high efficiency for both p-polarized and s-polarized light. In several embodiments, the waveguide includes Bragg-like gratings produced by extracting LC from HPDLC gratings, such as those described above, to enable high S and P diffraction efficiency over certain wavelength and angle ranges for suitably chosen values of grating thickness (typically, in the range 2-5 μm). Examples of waveguide based display devices are discussed in US Pat. Pub. No. 2018/0284440, entitled “Waveguide Display” and filed Mar. 30, 2018 which is hereby incorporated by references in its entirety.

### Waveguides Incorporating Protective Layers

Waveguides and waveguide displays can include protective layers in accordance with various embodiments of the invention. In many embodiments, the waveguide or waveguide display incorporates at least one protective layer. In further embodiments, the waveguide or waveguide display incorporates two protective layers, with one on each side of the device. As discussed in the sections above, waveguides and waveguide displays can be constructed with transparent substrates that, through their air interfaces, provide a TIR light guiding structure. In those cases, the protective layer can be implemented and incorporated such that there is minimal disruption to the substrates' air interfaces. In some embodiments, the protective layer can by virtue of its material properties and/or method of deposition onto a waveguide substrate, compensate for surface defects in the substrate, such as not limited to a surface ripple, scratches, and other nonuniformities that cause the surface geometry to deviate from perfect planarity (or other desired surface geometries). Protective layers can be implemented in various thicknesses, geometries, and sizes. For example, thicker protective layers can be utilized for applications that require more durable waveguides. In many embodiments, the protective layer is sized and shaped similar to the waveguide in which it is incorporated. For curved waveguides, the protective layer can also be curved. In further embodiments, the protective layer is curved with a similar curvature as the waveguide. Protective layers in accordance with various embodiments of the invention can be made of various materials. As can readily be appreciated, the properties of the protective layer, including but not limited to thicknesses, shapes and material compositions, can be selected based on the specific requirements of a given application. For example, protective layers can be implemented to provide structural support for various applications. In such cases, the protective layer can be made of a robust material, such as but not limited to plastics and other polymers. Depending on the application, the protective layer can also be made of glass, silica, soda lime glass, polymethyl methacrylate (PMMA), polystyrene, polyethylene, and other plastics/polymers.

In some embodiments, the protective layer can be incorporated using spacers to provide and maintain an air gap between the waveguide's substrates and the protective layers. Such spacers can be implemented similarly to those described in the sections above. For instance, a suspension of spacers and acetone can be sprayed onto the outer surface of the waveguide. In many cases, it is desirable to uniformly spray the suspension. The acetone can evaporate, leaving behind the spacers. The protective layer (which has had glue/adhesive/sealant/etc. added at the edges) can then be placed and vacuumed down into contact with the spacers. Although in some applications the spacers may move a small amount, they generally stay in place due to van der Waals forces. The spacers can be made of any of a variety of materials, including but not limited to plastics (e.g., divinylbenzene), silica, and conductive materials. In several embodiments, the material of the spacers is selected such that its refractive index does not substantially affect the propagation of light within the waveguide cell. The spacers can take any suitable geometry, including but not limited to rods and spheres. Additionally, spacers of any suitable size can be utilized. For instance, in many cases, the sizes of the spacers range from 1 to 30 μm. As can readily be appreciated, the shape and size of the spacers utilized can depend on the specific requirements of a given application. In some cases, the protective layer may advantageously be disposed further away from the waveguide. In such embodiments, larger sized spacers can be utilized.

The incorporation of protective layers can be implemented with different waveguide configurations, including single and multi-layered waveguides. For example, multi-layered waveguides can incorporate two protective layers, one disposed near each of the outer surfaces. In addition to providing environmental isolation and structural support for the waveguide, the protective layers can also be implemented for a variety of other applications. In many embodiments, the protective layer allows for dimming and/or darkening. The protective layer can incorporate materials for photochromic or thermochromic capabilities. The protective layer can also be configured to allow for controllable dimming and/or darkening. In several embodiments, the protective layer implements electrochromic capabilities. The protective layer can also provide a surface for other films, including but not limited to anti-reflective coatings and absorption filters. Such films can be implemented to avoid seeing light from the outside. In many cases, such films cannot be directly placed onto the waveguide, which can be due to the required high temperature processes or disturbance to the waveguiding in general. In a number of embodiments, the protective layer provides optical power. In further embodiments, the protective layer provides variable, tunable optical power. Such focus tunable lenses can be implemented using fluidic lenses or SBGs. In some applications, a picture generation unit is implemented and, depending on the waveguide application and design, may require an unobstructed light path between the PGU and the waveguide as the protective layer could refract the input beam, leading to positional errors. In many cases, an incident beam will contain rays that are at an angle to the waveguiding substrates. These effects will be exacerbated as the incident ray angles increase. Even for an incident beam that will not be refracted, there are still potential issues as the material used in the protective layer can impact the polarization of the beam and introduce scatter. In such embodiments, the protective layer can be designed and shaped accordingly to prevent the protective layer's interference with the light path.

### Eye Glow Suppression

### A. Diffractive Elements

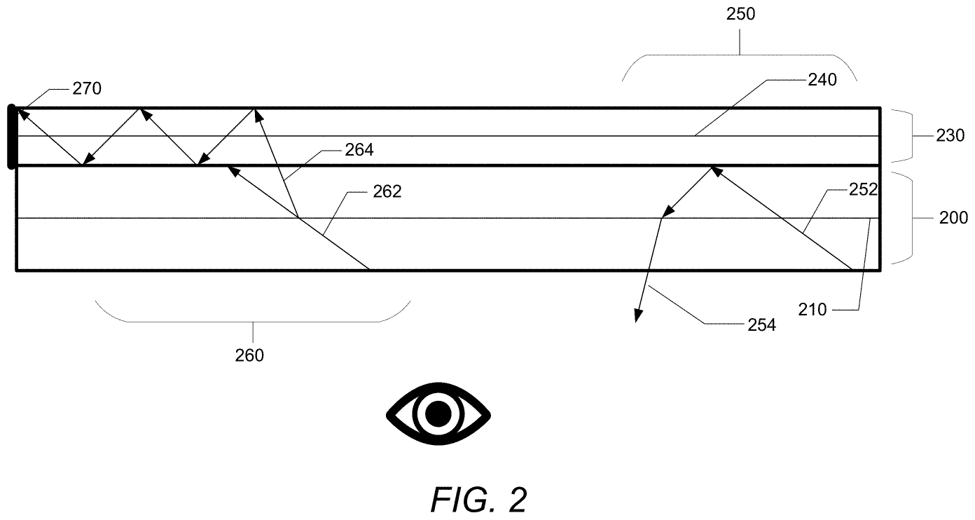

Eye glow suppression may be implemented in a partially light blocking layer which may include diffractive elements. The diffractive elements may be a reflection grating. In many embodiments, at least one reflection grating is implemented and utilized within a waveguide display system for suppressing eye glow. Reflection gratings can be introduced on the environmental of a waveguide display to reflect eye glow beams back into the waveguide that would otherwise escape. In many embodiments, this reflection occurs an angle that coincides with the angle of associated out-coupled light, preventing any distortion or ghost imaging from the perspective of the viewer. A waveguide display incorporating a reflection grating as an eye glow suppression structure in accordance with an embodiment of the invention is conceptually illustrated in FIG. 2. As shown, the system includes a waveguide 200 containing a grating layer 210 for providing in-coupling, propagation, and out-coupling of light. In the illustrative embodiment, the system includes a second waveguide 230 having a grating layer 240 with at least one reflection grating. The reflective grating layer 240 may include one or more holographic gratings sandwiched between two substrates similar to the gratings described above. In such configurations, the substrates of waveguides 200 and 230 are index-matched, forming a single TIR structure within which light can propagate. In the intended mode of operation for the first waveguide 200 as shown in area 250, a beam 252 traveling in a TIR path within the two waveguides 200, 230 can be out-coupled (254) towards a viewer by a grating within grating layer 210.

In contrast, area 260 illustrates an example of off-Bragg interactions that can cause eye glow. This example is not limiting and other causes of eye glow exist and are described above in connection with FIGS. 1A and 1B. As shown, ray 264 is a result of an off-Bragg interaction with a grating within grating layer 210 that originates from ray 262. Ray 264 passes through waveguide 200 and is incident upon a reflection grating within grating layer 230, where a portion of ray 264 is diffracted into the second waveguide 230. A light absorbing layer 270 may absorb the ray 264. The light absorbing layer 270 may absorb the eye-glow light diffracted by the diffractive element and block any outside light from being diffracted toward the light absorbing layer 270. The light absorbing layer 270 may be positioned in many places throughout the waveguide display such as toward the temple of the user with side-mounted projector or absorbing frame of glasses; toward the nose of the user; upward toward the projector mounting in top-down projector system; toward the edge of frame holding the waveguide; and toward other specific location with absorbing elements. The second waveguide 230 may include a thin substrate made of polycarbonate or glass. The thin substrate may be doped with a small amount (e.g. ˜5% tint) of absorbing dye at a desired wavelength. In some embodiments, through TIR, the eye-glow light may have a long path through the second waveguide 230 effectively absorbing all the light. Environmental light may have a short path through the second waveguide 230 but be left unchanged during transmission through the waveguide 230. In many embodiments, a small portion of the eye glow ray is not passed due to small errors in, or physical limitations of, the reflection grating layer 240 and continues on through waveguide 230 and manifests as eye glow. However, these rays are significantly weaker than typical unmitigated eye glow rays.

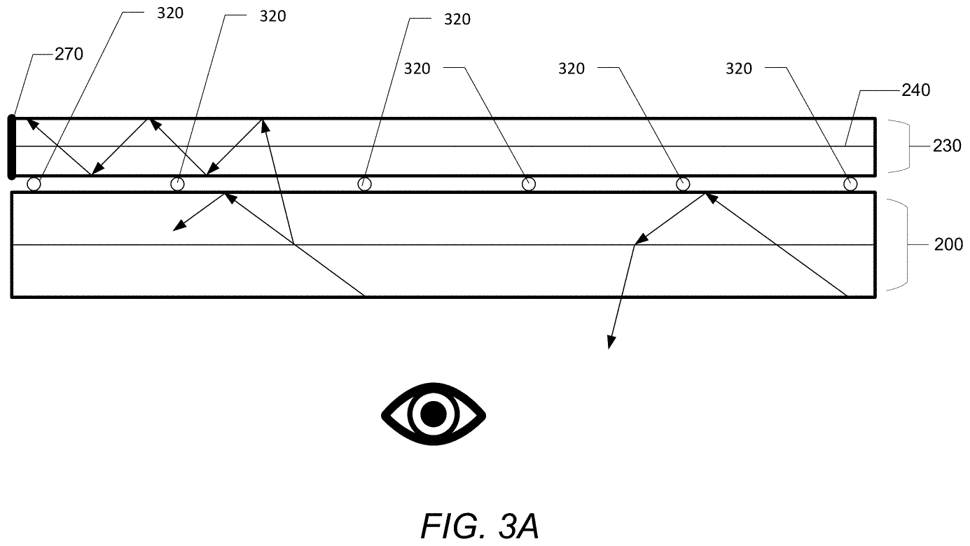

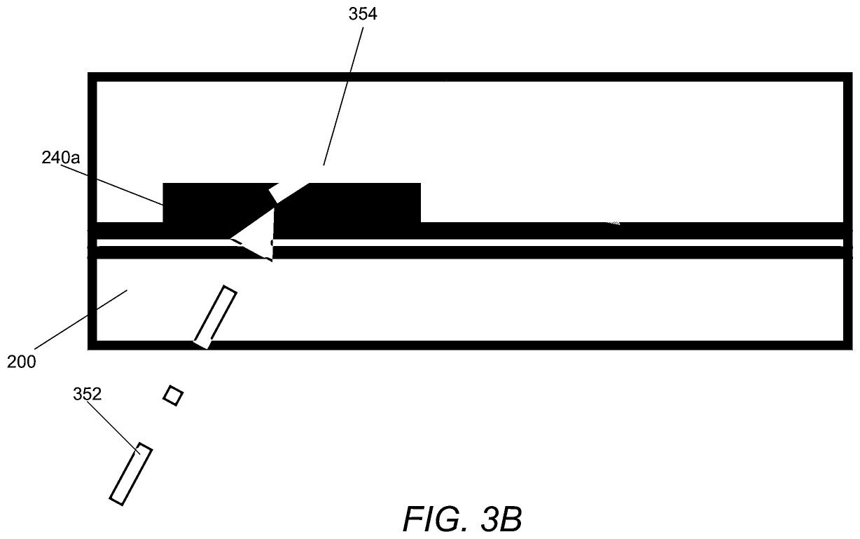

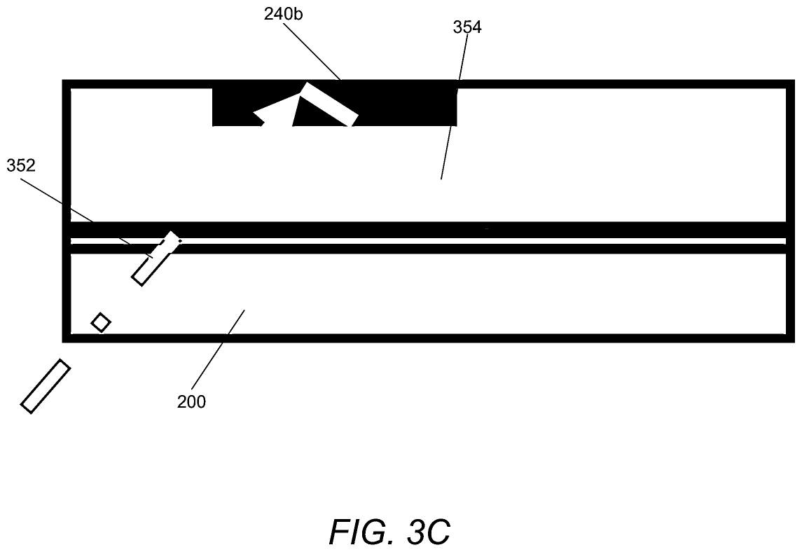

Although FIG. 2 illustrates a specific configuration of a waveguide display implementing a reflection grating for eye glow suppression, many other configurations can be implemented as appropriate depending on the specific requirements of a given application. For example, in the embodiment of FIG. 2, the waveguide containing the reflection grating is of the same size and shape as the base waveguide. In other embodiments, the waveguide containing the reflection grating is smaller than the base waveguide, covering a predetermined portion of the gratings within the base waveguide. Additionally, reflection waveguides do not need to be positioned such that they are touching the base waveguide. In numerous embodiments, there is a gap between the reflection and base waveguides. In many embodiments, the gap is air-filled, but can be filled with any material, such as but not limited to index-matching materials, as appropriate to the requirements of specific applications of embodiments of the invention. A reflection grating eye glow suppression structure with an air gap in accordance with an embodiment of the invention is illustrated in FIG. 3A. As shown, the waveguide 230 containing the reflection grating 240 is separated from the base waveguide 200 with an air gap through the use of spacer beads 320. In such embodiments, TIR paths of the main light rays are confined to the base waveguide 310.

In some embodiments, the reflection grating 240 may be a transmission diffractive element which may in-couple light into the waveguide through transmission diffraction. FIG. 3B illustrates an example of the diffractive elements as transmission diffractive elements in accordance with an embodiment of the invention. As illustrated, the transmission diffractive element 240a in-couples inbound light 352 into the waveguide through transmission diffraction. The in-coupled light 354 travels in total internal reflection through the waveguide. In some embodiments, the reflection grating 240 may be a reflective diffractive element which may in-couple light into the waveguide through reflective diffraction. FIG. 3C illustrates an example of the diffractive elements as reflective diffractive elements in accordance with an embodiment of the invention. As illustrated, the reflective diffractive element 240b in-couples inbound light 352 into the waveguide through reflective diffraction. The in-coupled light 354 travels in total internal reflection through the waveguide.

In some embodiments, the reflection grating 240 may be a holographic reflection grating. The holographic reflection gratings may be Bragg gratings and manufactured through holographic exposure as discussed above. In some embodiments, the holographic reflection gratings may be EBGs and manufactured in processes discussed above. In addition to holographic reflection gratings, other types of structures can be utilized to achieve a similar effect. For example, in some embodiments, the reflection grating 240 may be a surface relief reflection grating.

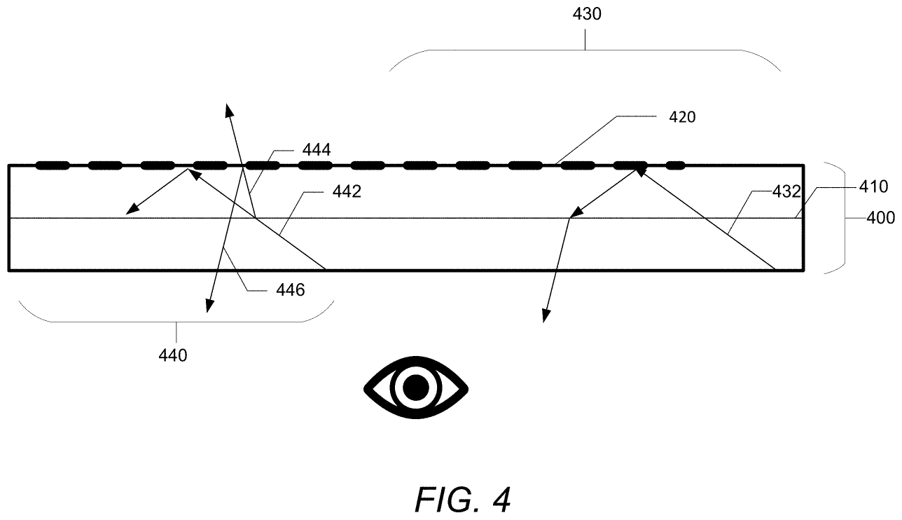

In some embodiments, the reflection grating 240 can be etched directly onto the surface of the side opposite the eye side of the waveguide. A waveguide display implementing a surface relief grating for eye glow suppression in accordance with an embodiment of the invention is conceptually illustrated in FIG. 4. The waveguide 400 includes a grating layer 410 and a surface relief reflection grating 420 disposed on the surface of the environmental side of the waveguide 400. In the region 430 illustrating the intended operation of the waveguide display, ray 432 in a TIR path within the waveguide 400 is diffracted out to the eye side by an output grating within grating layer 410. In the area 440 illustrating off-Bragg interactions, a portion of ray 442 is diffracted as eye glow ray 444 towards the environmental side of the waveguide 400. The eye glow ray 444 can be reflected by the surface relief reflection grating 420 back towards the eye side as ray 446. In many embodiments, ray 446 is parallel to a corresponding normal output ray. Again, a portion of ray 446 may be reflected due to Fresnel reflection back towards the surface relief reflection grating, but in turn may be at least partially reflected by the surface relief reflection grating 420 (not illustrated). While rays are shown as passing through the reflection grating 420, in numerous embodiments, this does not occur. However, due to imperfections and/or physical limitations, it may occur regardless. In some embodiments, the surface relief reflection grating 420 may include metasurfaces.

An advantage of surface relief reflection gratings is that they do not add significant volume to the display system. However, in numerous embodiments, the reflection gratings 240 described in connection with FIG. 2 can be placed on very thin substrates adjacent the waveguides with similar results. In some embodiments, the substrate can be disposed such that there is a gap between the substrate and the waveguide. The gap can be filled with any material, including (but not limited to) air.

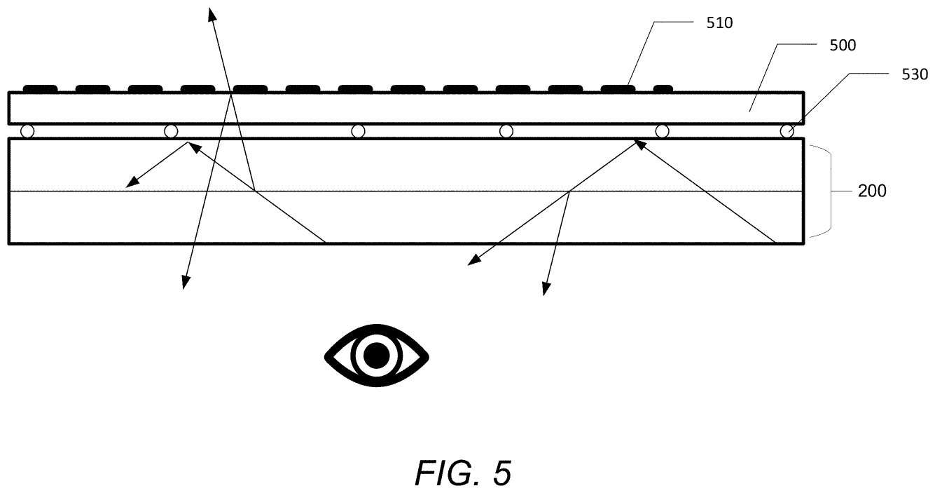

A reflection grating disposed on a separate substrate for suppressing eye glow in accordance with an embodiment of the invention is conceptually illustrated in FIG. 5. As shown, the waveguide 500 having a reflection grating 510 is separated with the base waveguide 200 using spacer beads 530. In the illustrative embodiment, the reflection grating 510 is disposed on the surface of the waveguide 500 facing the environmental side of the display. In other embodiments, the reflection grating 510 may be disposed on the surface facing the base waveguide 200.

While particular reflection waveguide eye glow suppression structures are illustrated in FIG. 2-5, any number and positioning of reflection waveguide optics can be used as appropriate to the requirements of specific applications of embodiments of the invention. Further, any number of different types of gratings can be added to suppress eye glow rays. For example, evacuated Bragg gratings can be used instead of surface relief gratings. Furthermore, non-grating structures can be used to suppress eye glow. These structures are described in further detail below.

### B. Reflective Elements

In some embodiments, eye glow suppression may be implemented in a partial light blocking layer which may include reflective elements. The reflective elements may include the use of filters, such as but not limited to dichroic reflectors and dielectric mirrors, that can accurately selectively pass certain wavelength bands while reflecting others. Dielectric reflective coatings may be applied to reflect the eye-glow light back to the user. The reflective coating may be designed as a narrow notch filter around the illumination wavelengths, effectively reflecting only specific wavelengths while transmitting all other visible wavelengths, allowing the waveguides to appear nearly transparent with a high transmission. The reflective coating may act as a mirror for the designed wavelengths, reflecting the light with an angle equal to the angle incident to the reflective coating layer. However, the reflected light may create a ghost image to the user when overlayed with the desired image diffracted by the output grating. In some embodiments, a filter such as a dichroic filter may be designed to have an angle-dependent reflection or transmission efficiency. Such filters may be multi-layered structures. The filter may be designed with polarization-sensitive efficiencies. Using one or more of spectral, angular, or polarization filter characteristics may help to optimize the suppression of eye glow. In some embodiments, the eye glow suppression may balance a higher degree of eye glow suppression in the central portion of the user's field of view against residual eye glow at the periphery of the user's field of view.

The coating may be applied in various locations. For example, the coating may be applied on each waveguide individually, which may allow for larger angular deviations before ghosting is apparent. The coating may also be applied on a front protective cover. It has been observed that further distance from the user may create a larger deviation between desired image and ghost image. In some embodiments, the front protective cover may be spaced further from the waveguide hence offering a little more optical path. The added path length could be used to reduce coherence of artifacts such as Newton's Rings fringes in laser beam scanner (LBS) projectors. Advantageously, the reflection may be aligned to the eyeside ‘signal’ image. In some embodiments, the misalignment may be minimal which may be on the scale of the resolution of the image of the eye glow reflection vs the signal image; if misalignment does occur, this may lead to image point spread function broadening and hence loss of image sharpness, or if the reflection angle error is larger, then it will cause a ghost image. The coherence of the eye glow reflection may be considered in the case of laser illumination solutions, particularly with laser beam scanners (LBS). In some embodiments, a phase scrambler on the non-eye side of the waveguide may cause the Fresnel reflections to be out of phase with the signal light which may decrease the Newton's rings fringe artifacts which may be found with LBS projectors. The application of an ‘eyeglow suppression’ spectral notch reflection filter could increase the intensity of Newton's rings fringes from LBS, where LBS Newton's rings are caused by the interference of the signal beam and the non-eyeside reflection. In some embodiments, antireflection coatings on the non-eyeside may be included leading to a reduction in both eyeglow and LBS Newton's rings fringes.

In some embodiments, the protective cover may be plastic. In this case, when the reflective coating is applied to the protective cover the thermal property limitations during coating may be minimal. For example, if a grating was made using a thermally sensitive materials, then a low temperature coating (e.g. 50-60 degrees C.) might be beneficial. In embodiments where the protective cover is made of glass a high temperature coating may be used. A reflective coating may be applied to one side of the protective cover for one waveband (e.g. a green reflective notch), and another reflective coating may be applied to the other side coated with different waveband (e.g. a red/blue notch). It is appreciated that any combination of wavebands may be used (e.g. any other combination of R,G,B notches). The reflective coating may be combined with see thru AR, UV protection, gradient absorption or dimming coatings, anti-scratch or hard coat coatings.

It may be advantageous for the reflective layer to be flat and laminated to the waveguide to decrease angular offset from reflected eye-glow light and the desired image. In some embodiments, a material may provide flatness between layers (e.g. thickness shims, spacer beads, etc). The reflective layer may be laminated to the waveguide or waveguide stack. In some embodiments, the reflective layer may be a narrow notch reflector designed for lasers which partially reduces LED eye glow when the notch lies within the spectrum of the LED.

Depending on construction, the reflective layer may pass a wide range of colors except for a specific band (or set of bands) which is reflected, or act as a high-pass or low-pass filter which reflect all wavelengths less than, or higher than, a given wavelength, respectively. In some embodiments, alternating thin layers of dielectric material is coated to form the desired filter. As described herein, dichroic reflectors or dielectric mirrors can be applied to waveguides to reflect eye glow rays in a manner which produces similar results as those described above with respect to reflection gratings, although with different underlying operating principles.

The waveguide 600 includes a dichroic reflector 610 on the surface facing the environmental side. The waveguide 600 may include a grating layer 602 which is the same as the grating layer 210 which was discussed in connection with FIG. 2. The dichroic reflector 610 may be designed to reflect a predetermined wavelength band of light that correspond to waveguide 600. For example, in a multi-layered waveguide display having three layers for R, G, and B, the dichroic reflector 610 for a given waveguide layer can be designed to reflect light in which the given waveguide layer is intended to operate (e.g., the dichroic reflector for the red waveguide can be designed to reflect a wavelength band corresponding to red light from the light source). Similar to a surface relief grating, the dichroic reflector 610 can reflect at least a portion of rays that would otherwise escape and manifest as eye glow back towards the viewer. Similar as to described above in connection with FIGS. 2-5, intended rays are shown in area 620, whereas eye glow rays generated by off-Bragg interactions and their suppression are shown in area 630. Again, while intended rays and eye glow rays are shown separately, it is readily appreciated that these rays occur concurrently throughout the waveguide.

When using dichroic reflectors, a percentage of environmental light that is able to pass through the waveguide display to the viewer's eyes may be diminished. Therefore, while eye glow rays are reflected back towards the eye, light from the outside world corresponding to similar wavelength bands can also be prevented from reaching the viewer's eyes. This may cause problems in augmented reality systems in which it may be desirable for the user to be able to see the world as clearly as possible. To address this, dichroic reflector structures may be designed as a notch filter which may selectively reflect the wavelength band that is used in the waveguide (e.g. the colors selected for the particular waveguide). For example, a narrow band can be selected around 638 nm, 520 nm, and 455 nm (standard display red, green, and blue, respectively) in order to suppress eye glow while keeping the remainder of the visible spectrum (e.g. 440-640 nm) unaffected. As can readily be appreciated, the selected band can correspond to the wavelength bands of the light source.

Further, dichroic reflectors are often applied at high temperatures which, depending on the construction of the waveguide and/or any antireflective coatings, may cause deformation to the waveguide. To avoid this, a lower temperature dichroic reflector application process can be used. In numerous embodiments, the dichroic reflector can be included in a protective layer of a waveguide.

Dichroic reflectors (or indeed, waveguides) can be applied in multiple iterations or as a single application depending on the needs of the overall system. For example, as described above, in an RGB display where three different waveguides are used for each of R, G, and B, a dichroic reflector (or reflection grating/reflection waveguide) can be interspersed between the three different waveguides or on the environmental side of the waveguide stack.

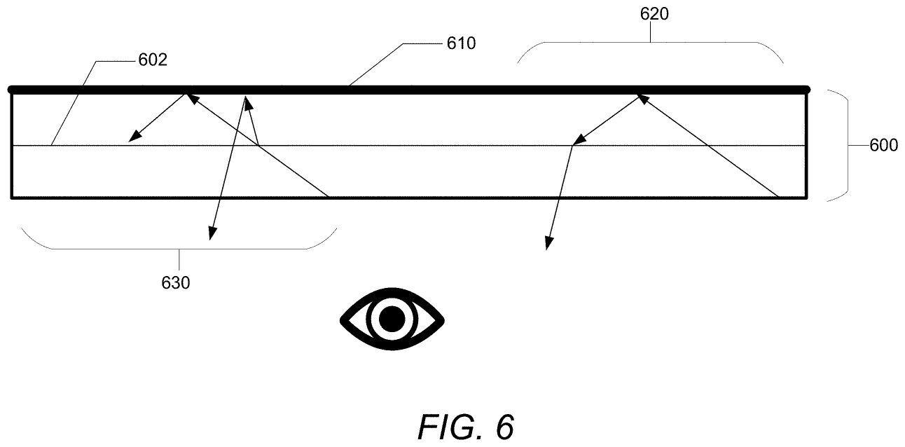

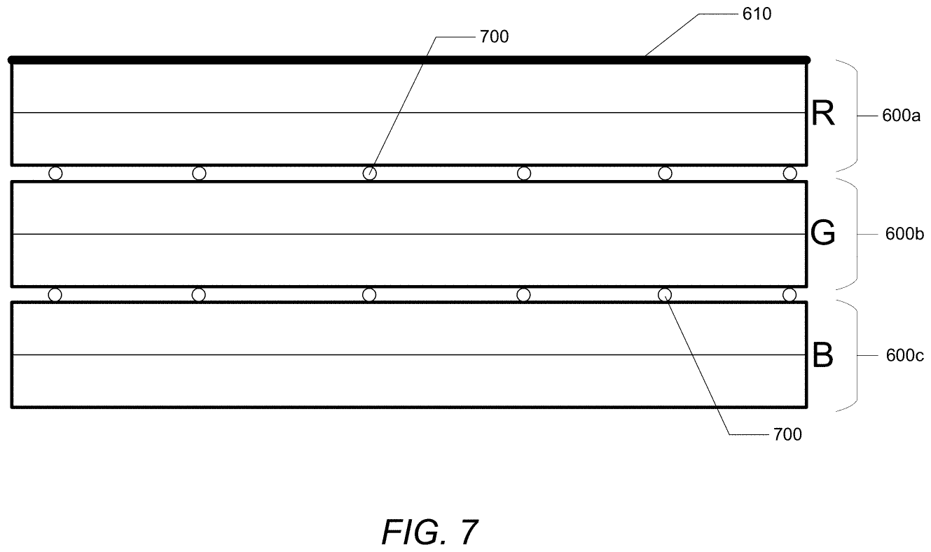

Example configurations of dichroic reflector applications in accordance with embodiments of the invention are illustrated in FIGS. 7-9. FIG. 7 illustrates an example of a waveguide-based display including three different waveguides in accordance with an embodiment of the invention. A first waveguide 600a may be configured to display a first color such as red, a second waveguide 600b may be configured to display a second color such as green, and a third waveguide 600c may be configured to display a third color such as blue. Each of the waveguides 600a,600b,600c may include the features of the waveguide 200 described in connection with FIG. 2. The dichroic reflector 610 described in connection with FIG. 6 may be applied to the top of the first waveguide 600a. Spacers 700 may be applied to between adjacent waveguides. The gaps between adjacent waveguides may be filled with various materials such as air.

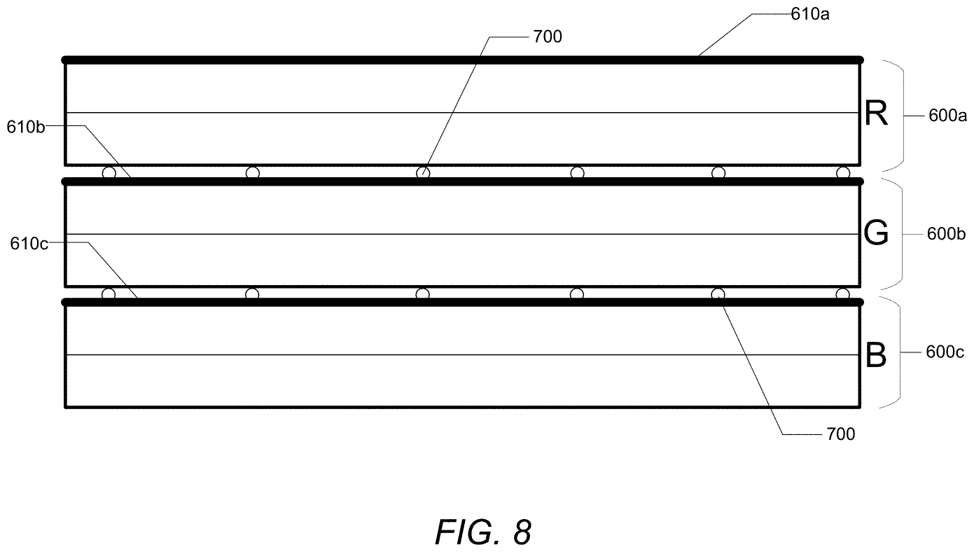

FIG. 8 illustrates an example of a waveguide-based display including three different waveguides in accordance with an embodiment of the invention. This configuration includes many of the same features as the device of FIG. 7. This description is applicable and therefore the description will not be repeated. A dichroic reflector 610b may be applied to the top of the second waveguide 600b and a dichroic reflector 610c the third waveguide 600c. The dichroic reflector 610a may as well as be on the top of the first waveguide 600a. In this configuration, the dichroic filter 610a,610b,610c may be tailored to the specific waveguide 600a,600b,600c.

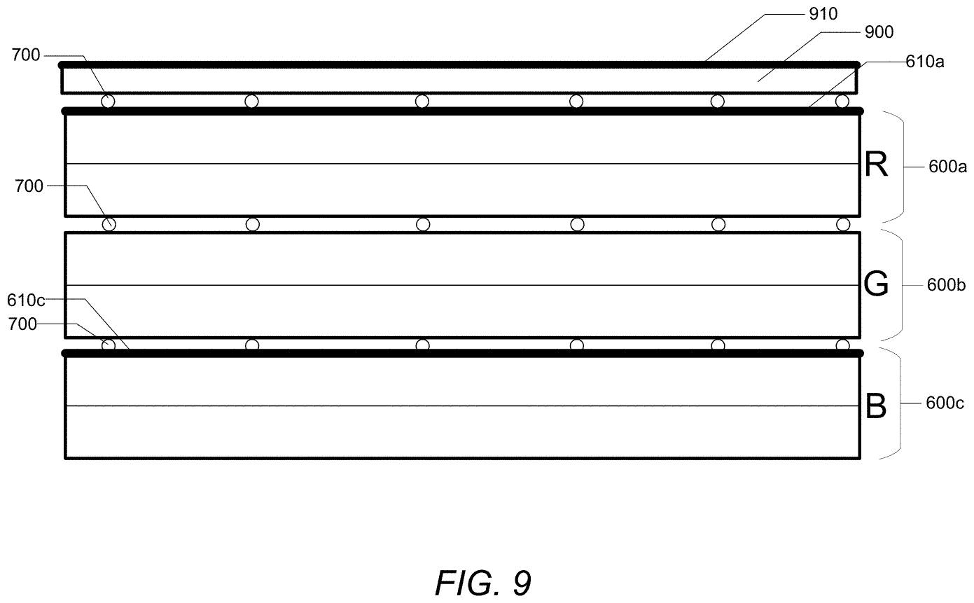

FIG. 9 illustrates an example of a waveguide-based display including three different waveguides in accordance with an embodiment of the invention. This configuration includes many of the same features as described in connection with FIGS. 7 and 8. These descriptions are applicable and therefore these descriptions will not be repeated. The dichroic filter 610b of the second waveguide 600b has been removed. Instead, a dichroic filter 910 placed in a separate substrate 900 may be placed above the first waveguide 600a. The separate substrate 900 may be a protective layer. The dichroic filter 910 on the separate substrate 900 may correspond to the second waveguide 600b. For example, the second waveguide 600b may be a green waveguide and the dichroic reflector 910 may correspond to green and be applied to the protective layer 900.

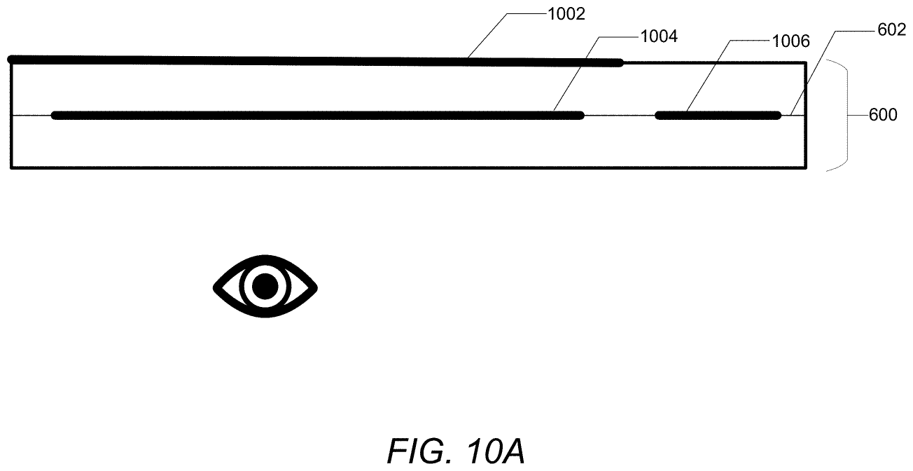

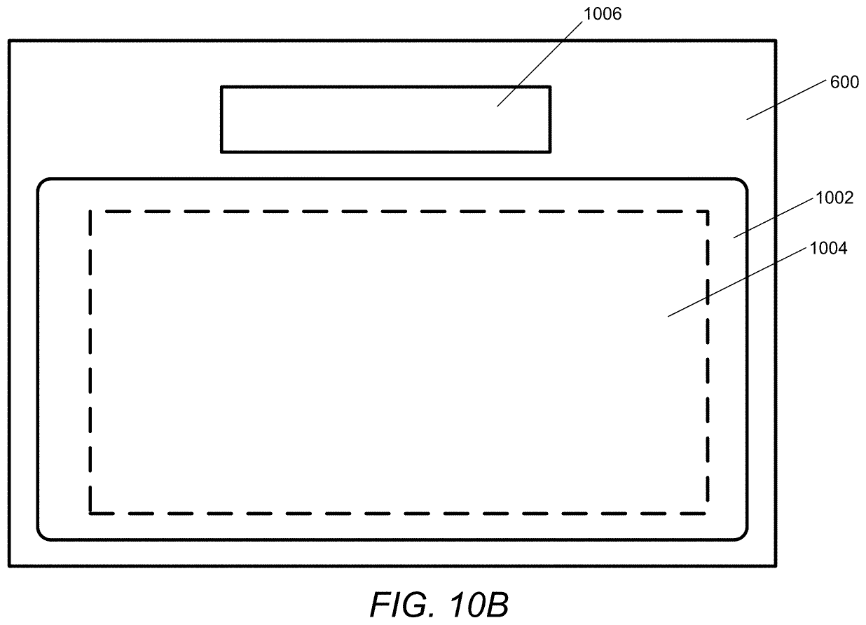

FIG. 10A illustrates a cross sectional view of a waveguide-based display including a dichroic filter in accordance with an embodiment of the invention. FIG. 10B illustrates a schematic plan view of the waveguide-based display of FIG. 10B. The waveguide 600 includes an incoupling optical element 1006 and an outcoupling optical element 1004. A dichroic filter 1004 overlaps the outcoupling optical element 1004. In some embodiments, the dichroic filter 1004 may not overlap the incoupling optical element 1006.

As can be readily appreciated, any number of dichroic reflectors (or reflection gratings/reflection waveguides) can be used as appropriate to the requirements of specific applications of embodiments of the invention. For example, only two dichroic reflectors might be used for a stack of three waveguides depending on the requirements of the design. Furthermore, it is understood that any mix of eye glow suppression structures can be used as appropriate to the requirements of specific applications of embodiments of the invention. Eye glow suppression structures do not necessarily need to reflect light. An alternative eye glow suppression structure is described below.

### C. Absorbing and Transforming Layers

The eye glow suppression layer may include a light absorbing layer which may absorb light in a portion of the visible light spectrum. The light absorbing layer may be a narrowband dye absorber layer which may include a light absorbing dye suspended in a transparent matrix. Dye for absorption may be extremely narrow in wavelengths absorbed. Any unnecessary wavelengths absorbed will cause the waveguide to have a lower transmission, dimming the outside world and appearing dark. The location of the dye absorbing layer may vary. The dye absorber layer may be positioned on a protective cover if using multiple waveguides to guide one color FOV. If each waveguide is only guiding one color, then the dye can be applied to a protective cover on the front of the waveguide stack. Dyes may be angularly insensitive, covering a broad range of incident angles of eye-glow light. Exemplary dyes for the visible light region are manufactured by Yamada Chemical Co., Ltd (Japan). High absorption efficiency, narrow spectral absorption bandwidth and thermal stability may be important selection criteria. One possible approach for improving the absorber performance involves dilution of the dye in a transparent matrix, which can be an inert organic polymer compound or an inorganic compound. The resulting absorber can give narrow band absorption and high out of band transmittance. A multilayer configuration may allow absorption of more than one wavelength.

In some embodiments, the light absorbing layer may be a metamaterial absorbing layer. Metamaterial absorbers can be created with an extremely narrow spectral bandwidth. Absorption may be sensitive to angular deviations when it has such a narrowband absorption. The metamaterial absorbing layer may be placed on each waveguide individually if not sharing colors through multiple waveguides. The metamaterial absorbing layer may be placed on a protective cover above the top waveguide if sharing the colors in the waveguides.

Many of the eyeglow suppression solutions discussed may be implemented using metasurfaces which would include surfaces patterned with one or more types of nanostructures. Metasurfaces may be configured for light absorption, beam deflection and polarization as functions of one or both wavelength or angle. More than one of the above functions can be integrated into a single metasurface. Metasurfaces can offer complete or partial solutions to suppressing eye glow contributed by specular reflections from waveguides surface, eye surfaces and scattering surfaces.

The eye glow suppression structure may include wavelength altering elements such as quantum dots or phosphors. Quantum dots are nano-scale semiconductors that can absorb light of a first wavelength and emit light of a second wavelength. Quantum dots can be introduced into the substrate of a waveguide or applied to the loss side of a waveguide optic system to suppress eye glow rays. For example, quantum dots that absorb eye glow rays of a specific wavelength and emit light at a non-visible wavelength (e.g. infrared) can suppress eye glow rays from producing visible eye glow rays. The eye glow rays may still escape the waveguide however these eye glow rays may altered into the non-visible range. In many embodiments, the infrared and lower band is desirable due to the biologically harmful properties of ultraviolet light. However, depending on the use of the waveguide optic system, it may be acceptable to transform the light into the ultraviolet or higher band.

Depending on the quantum dots available, it may be difficult to shift higher frequency light (e.g. blue light) towards the infrared band. In this situation, series of different quantum dots can be used to shift the light wavelength in stages, and/or quantum dots can be incorporated into a waveguide optic system which also leverages one or more of the alternative eye glow suppression structures described herein. Depending on the number of wavelengths used in the waveguide optic system for display purposes, different sets of quantum dots can be applied to mitigate some or all of the different wavelengths.

As can be readily appreciated, quantum dots can be incorporated into a system that includes any or all of the above eye glow suppression structures. Indeed, while particular eye glow suppression structures are illustrated in the figures discussed above, any number of different architectures can be used which incorporate eye glow suppression structures as described herein.

### D. Embodiments Including Synchronization

In many applications, it is desirable for the waveguide display to operate with a large eyebox. Although convenient for the viewer, this can produce a large amount of unused light impinging the user's face (e.g., light that does not reach the user's pupils). Depending on the implementation of the waveguide display, this unused light can be quite visible to an outside observer. As such, many embodiments of the invention are directed towards solutions for reducing the amount of unused light incident upon the user's face while preserving the operating size of the eyebox.

In many embodiments, the waveguide display includes at least one switchable Bragg grating (SBGs) for the control of out-coupled light to reduce the amount of unused light. Typically, eyebox size can be enlarged by multiplying or replicating in-coupled light through the use of diffractive gratings. If switchable Bragg gratings are implemented, the display can be configured to control the propagation of light such that only light that would reach the viewer's eye(s) is out-coupled, thereby reducing the amount of unused light ejected towards the user's face. In many embodiments, the required configuration for achieving such control is determined dynamically as the user's eyes are typically not static during operation. Accordingly, the configuration can also be implemented dynamically once determined.

In some embodiments, with a high brightness light source, a small duty cycle (˜1%) can be used with the required output luminance. With this light source, an absorbing layer can be switched on and off, synchronized with the light source. This may absorb the eye-glow light while the source is on, but appear transparent to the observer averaged over many cycles. In some embodiments, the absorbing layer may be a switchable grating such as SBGs. The switchable grating may include a diffractive eye-glow element. This decreases the time of possible unwanted light being diffracted back toward the user through the diffractive element. The switchable gratings may be switchable output gratings. The switchable output gratings may be multiplexed grating schemes with a switching waveplate. For multiplexed gratings, the output light may be polarized after mixing from multiple gratings. If the gratings are switched in time, each grating may create a highly polarized output. In some embodiments, switching a waveplate synchronized with the switchable gratings may rotate the polarization of one or both outputs to be orthogonal with a linear polarizer at the output which may block the eye glow light. In some embodiments, switching a linear polarizer to be orthogonal with light output from the switchable grating may block the eye-glow light without having a permanent linear polarizer on the output. In some embodiments, switchable subwavelength gratings (based on the principle of form birefringence) may provide a wavelength specific optical retarder for synchronising eyeglow suppression with the light source. In some embodiments, the grating pitch may be much less than the wavelength of light. Thus, only the zero order and diffracted waves propagate and the higher diffracted orders may be evanescent.

Determining the required configuration to out-couple only light that will reach the user's eyes can be achieved in a variety of ways. In many embodiments, the waveguide display includes an eyetracker. The eyetracker can be implemented in many different ways. In some embodiments, a waveguide-based eyetracker is implemented to determine eye position and/or eye gaze information. Using information from the eyetracking sensor, the waveguide display can utilize a controller to implement a configuration of the states of the switchable Bragg grating to only out-couple light that would reach the user's eye. In some embodiments, the light that is outcoupled out of the waveguide otherwise would continue propagating through the waveguide to the edges. As can readily be appreciated, waveguide displays in accordance with various embodiments of the invention can be designed to mitigate unused light from escaping the edges of the waveguide. For example, the edges can be covered with a light absorbing material which may absorb any light that reaches the edges.

In implementing switchable Bragg gratings, the waveguide can include a transparent electrode such as an indium tin oxide (ITO) or index-matched ITO (IMITO) layer on either side as electrodes for switching the gratings between their ON/OFF states. In many embodiments, the waveguide includes a first ITO/IMITO layer on one side of grating layer and a second ITO/IM ITO layer on the opposing side. The second layer can be patterned into selectively addressable elements. This allows for the switching of discrete areas of the switchable Bragg gratings. In some embodiments, the selectively addressable elements are large enough as to not introduce line/gap artifacts, which can result in noticeable scattering and/or diffractive effects. As can readily be appreciated, various transparent conductive oxide layers can also be utilized.

With the incorporation of these layers, absorptive losses by layers, that can be substantial, may be considered in the waveguide design. For example, some ITO layers can contribute ˜0.25% of absorptive loss per pass. Depending on the waveguide architecture, the total propagation loss down the waveguide can be substantial. For example, controlling the amount of out-coupled light can include switching a portion of the output grating to its diffractive state. The switched portion can correspond to the viewer's eye position and/or eye gaze information. However, under such schemes, the distance in which the light propagates through the waveguide can vary, which when taken in consideration with the absorptive losses due to the ITO/IMITO layer(s) can result in varying losses in the out-coupled light. By modifying the output grating size and/or shape through the use of switching, the light propagation path can result in different amounts of TIR bounces within the waveguide (e.g., some configurations can result in longer light paths that interacts with the ITO/IMITO layer(s) a higher number of times). For light paths that interact with the ITO/IMITO more, the total losses in light intensity may be higher, resulting in non-uniformity across different configurations. As such, many embodiments are directed towards grating architectures and switching configurations designed to account for these differences. In many embodiments, the waveguide display may be configured to include an output grating having independently addressable sections capable of switching between diffractive and non-diffractive states. In some embodiments, the waveguide display can be configured to provide a scrolling output (e.g., the output image may be displayed in sections that are scrolled sequentially). In such cases, the output configuration for a certain eye position/eye gaze setting can be configured to have a uniform profile. In some embodiments, the switching can include a feathering effect with regards to switching timing to retain field uniformity.

### E. Embodiments Including Anti-Reflection Coatings

Eye glow may be caused by several different effects. These effects may be split into collimated leakage and scattered leakage. Scattered leakage may be generated by hologram material, waveguide material, or holographic haze (haze recorded in the hologram). Scattered leakage may cause light to be scattered out of the waveguide towards the eye. Collimated leakage may preserve angular integrity (e.g. a net sum zero k-space solution; a path with low diffraction efficiency). With no k-vector error, the collimated image may be preserved and outputted from the waveguide away from the user.

For collimated leakage, off Bragg diffraction may be weak diffraction in the off Bragg interaction which may lead to light exiting the waveguide. If a ghost grating occurs in the holographic recording process as a result of stray light or scattering centers resulting from incomplete phase separation, an apparent off Bragg interaction may arise from the ghost grating, which may manifest itself within a multiplexed grating. This type of grating might be weakly recorded and might be difficult to separate from an off Bragg grating. The effect may be to collimate light diffracting out of the waveguide in the wrong direction. For Fresnel reflections, light diffracted from the grating plane towards the eye of the user may exit the waveguide. At the interface of the waveguide (on the eye side) and air, a Fresnel reflection may occur. Reflection from this interface will mostly exit from the waveguide on the user side. However, a small fraction of that light may in turn reflect back from the waveguide/air interface on the non-user side of the waveguide. Additionally, some light reinteracts with the grating following reflection from the waveguide/air eyeside reflection. In some embodiments, Fresnel reflections may be alleviated through an AR coating on the waveguide. Waveguides including higher index glass may have higher Fresnel reflections. AR coating therefore may reduce eye glow. Furthermore, the eye of the user can contribute reflected light which can take the form of scatter and specular reflections, most typically a mixture of the two. Contributions to the scatter or reflection from the user's eye may occur at any of the surfaces or optical media in the eye and can include Purkinje reflections. Scattered light from the hologram and waveguide material and from haze recorded into a hologram may have directional and isotropic characteristics determined by the nature of the scattering centres. Some of this light may go straight through the waveguide outer surface. Other exit paths may include a reflection at the eye of the user and surfaces of the waveguide near the user.

### F. Embodiments Including Liquid Crystal Layers

In some embodiments, liquid crystal layers may be supported by the waveguide to decrease eye glow. The liquid crystal layers may be cholesteric liquid crystal layers. Liquid crystal layers may offer narrow band reflection gratings which may offer high diffraction efficiency. The liquid crystal layers may be inexpensive to manufacture. The liquid crystal layers may be configured in multilayer stacking to cover multiple waveband notches (e.g. R/G/B laser light sources). A chiral dopant may be added to the liquid crystal layers to control grating period.

In some embodiments, an eye glow control layer may be included on the waveguide. The eye glow control layer may include polymerizable liquid crystals called Liquid Crystal Polymers (LCPs), also known as reactive mesogens. LCPs may have all the usual properties of LC but can also be polymerized to form solid materials with LC alignment and birefringence properties existing in the liquid state being retained when the material is solidified in a polymer. UV alignment may be used to align the LC directors into desired directions while the LC is in its liquid state. LCPs can enable a range of optical functions such as selective colour reflectors, retardation (quarter wave, half wave etc) and others. LCPs may contain liquid crystalline monomers that such as reactive acrylate end groups which polymerize with one another in the presence of photo-initiators and directional UV light to form a rigid 2D or 3D network. An LCP eyeglow control layer may be used in conjunction with other eye glow control layers as discussed throughout this disclosure. Exemplary LCP materials are developed by Merck KGaA (Germany). In some embodiments, the eye glow control layer may be based on tuneable reflection filters using reflective cholesteric reactive mesogen nanopost structures. The reflection wavelength may be dependent on the pitch of the nanoposts, which can be fabricated using printing techniques. Nanoposts may be typically formed as arrays of features of height between 10 micron and 500 nm with pitch in the range of 1-10 micron.

### G. Embodiments Including Waveguide Output Polarization Designs

Output eye glow leakage may be strongly, but not perfectly polarized in waveguide solutions where the output grating may be represented with a single grating. In some embodiments, strongly polarized eye glow leakage may be minimized using a linear polarizer (e.g. analyzer) placed in front of the waveguide, but at the expense of see through transmission. Output gratings with cross multiplexed output gratings (e.g. Integrated Dual Axis-expansion IDA designs) may not have linear output polarization states: in such gratings the polarization matches the k-vectors of each of the constituent multiplexed (MUX) gratings. If MUX output gratings are at 90 degrees with respect to each other, then the output polarization may be mixed; a linear analyzer will then only serve to partially cut down the eye glow. In some embodiments, MUX output gratings minimize the k-vector components of each grating in one particular direction (e.g. minimize the vertical component of the k-vector) leaving only horizontal components in opposite directions. Even if the gratings were not completely aligned (in opposite directions) and were arranged such that one direction had stronger output polarization than the orthogonal direction, then use of a linear analyzer would still be beneficial. In some embodiments, where the MUX output structure k-vectors are largely in opposite directions, a linear analyzer may not completely block eye glow leakage, although an orientation can be found where the eye glow can be blocked by a factor greater than the loss factor in see through transmission by the linear analyzer. In some embodiments, the orientation of the eye glow polarization may be strongly aligned with the k-vector in anisotropic output gratings, and orthogonal to the k-vector in anisotropic gratings.

In some embodiments, a dimming layer may be applied to a top surface of the waveguide which may reduce eye glow. However, a dimming layer may also reduce optical see thru transmission as well. In some embodiments, the dimming layer may be a passive dimming layer or an active dimming layer. The active dimming layer may be an electro-chromic or photochromic dimming layer. In some embodiments, the active dimming layer may provide a temporal transmission variation matched to and synchronized to the luminance of the image content displayed by the projector (e.g. picture generation unit).

In some embodiments, microlouver films may be applied to a top surface of the waveguide which may reduce eye glow. The microlouver films may be used to suppress eye glow at extreme angles which may be at the limit of the effective angular bandwidth of many of the gratings and thin film coating solutions described throughout this disclosure. The microlouver film may be combined with a polarizer. Exemplary microlouver films are Light Control films manufactured by 3M Company (Minnesota).

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A waveguide based display device comprising:
a waveguide comprising an in-coupling optical element and an out-coupling optical element, wherein the in-coupling optical element is configured to in-couple image modulated light and the out-coupling optical element is configured to out-couple the image modulated light towards a user, wherein the waveguide comprises an outer surface and an inner surface opposite to the outer surface, and wherein the inner surface is closer to the user than the outer surface; and
a partially light blocking layer above the outer surface of the waveguide opposite to the user,
wherein the partially light blocking layer is configured to keep eye glow light exiting the outer surface of the waveguide from entering the environment outside the outer surface of the waveguide.

2. The display device of claim 1, wherein the eye glow light comprises light directed out of the outer surface away from the user.

3. The display device of claim 2, wherein the eye glow light is light reflected by the out-coupling optical element, the in-coupling optical element, and/or the inner surface.

4. The display device of claim 1, wherein the waveguide causes the in-coupled light to be directed in total internal reflection (TIR) between the inner surface and the outer surface.

5. The display device of claim 1, wherein the partially light blocking layer absorbs light in a portion of the visible light spectrum.

6. The display device of claim 5, wherein the partially light blocking layer comprises a narrowband dye absorber layer.

7. The display device of claim 6, wherein the narrowband dye absorber layer comprises a light absorbing dye suspended in a transparent matrix.

8. The display device of claim 5, wherein the partially light blocking layer comprises a metamaterial absorbing layer.

9. The display device of claim 8, wherein the metamaterial absorbing layer comprises an absorber formed in a metamaterial.

10. The display device of claim 1, wherein the partially light blocking layer deflects light in a portion of the visible light spectrum toward the user.

11. The display device of claim 10, wherein the partially light blocking layer comprises a dielectric or dichroic reflector.

12. The display device of claim 1, wherein the partially light blocking layer transforms the light in a portion of the visible light spectrum to non-visible radiation.

13. The display device of claim 12, wherein the partially light blocking layer comprises quantum dots or phosphors.

14. The display device of claim 1, wherein the partially light blocking layer diffracts light in a portion of the visible light spectrum into a path that does not enter the environment.

15. The display device of claim 14, wherein the partially light blocking layer comprises a reflective or transmissive diffractive structure.

16. The display device of claim 14, wherein the partially light blocking layer comprises a reflective grating layer.

17. The display device of claim 16, wherein the reflective grating layer is configured to direct light towards a light absorbing element.

18. The display device of claim 16, wherein the reflective grating layer is positioned between two waveguide substrates.

19. The display device of claim 16, wherein the reflective grating layer comprises a holographically recorded grating.

20. The display device of claim 14, wherein the partially light blocking layer comprises a plurality of overlapping diffractive structures, each structure configured to diffract a unique angular bandwidth of eye-glow light and diffract it onto a light absorbing element.

21.-52. (canceled)
